(19) United States
(12) Patent Application Publication
(10) Pub. No.: US 2014/0375609 A1
(43) Pub. Date: Dec. 25, 2014

(54) APPARATUS AND METHOD FOR DETECTING TOUCH, CAPABLE OF REDUCING PARASITIC CAPACITANCE

(71) Applicant: CRUCIALTEC CO., LTD., Chungcheongnam-do (KR)

(72) Inventor: Dong Woon Kim, Seoul (KR)

(21) Appl. No.: 14/374,530

(22) PCT Filed: Jan. 25, 2013
(86) PCT No.: PCT/KR2013/000624

§ 371 Date: Jul. 25, 2014

(30) Foreign Application Priority Data
Jan. 27, 2012 (KR) 10-2012-0008415

(51) Int. Cl. G06F 3/044

(52) U.S. Cl. CPC G06F 3/044; G06F 2203/04112
USPC 345/174

(57) ABSTRACT

A touch detection apparatus includes at least one sensor pad outputting a signal according to a touch state in response to an alternating voltage in a floating state after charging with an electric charge, an additional electrostatic capacitive unit electrically connected to an output terminal of the sensor pad and having a capacitance corresponding to a parasitic capacitance of the sensor pad, an electrical charging/discharging unit charging or discharging the additional electrostatic capacitive unit to make the additional electrostatic capacitive unit have an electric charge variation the same as that in the parasitic capacitance caused by the alternation of the alternating voltage but an opposite polarity, and a level shift detection unit detecting a touch signal based on a difference between voltage variations in the sensor pad caused by the alternating voltage during non-touch and caused by the alternating voltage during a touch.

### CROSS REFERENCE TO RELATED APPLICATIONS AND CLAIM OF PRIORITY

This patent application is a National Phase application under 35 U.S.C. §371 of International Application No. PCT/KR2013/000624, filed Jan. 25, 2013, entire contents of which are incorporated herein by reference.

### BACKGROUND

1. Technical Field

The present invention relates to a touch detection method and apparatus, and more particularly, to a touch detection method and apparatus which may reduce the effect of a parasitic capacitance by adding an additional capacitance for offsetting the parasitic capacitance.

2. Background Art

A touch screen panel is an input device in which a user's command can be input by touching the input device with a person's hand or other contact means based on contents displayed by an image display apparatus.

For this, the touch screen panel is provided on a front face of the image display apparatus to convert a contact position in direct contact with the person's hand or the other contact means into electrical signals. Thus, instruction contents which are selected at the contact position may be accepted as input signals.

Such a touch screen panel may be replaced with an input device such as a keyboard or a mouse, and therefore the utilization range of the touch screen panel tends to be gradually increased.

As a scheme of implementing the touch screen panel, an electrostatic capacitance scheme, an optical detection scheme, a resistance film scheme, and the like have been widely known. Among these, a capacitive type touch panel converts a contact position into electrical signals in such a manner that a conductive detection pattern detects a change in the capacitance formed between the conductive detection pattern and peripheral other detection patterns or a ground electrode when a person's hand or an object contacts the touch panel.

FIG. 1a is a plan configuration diagram illustrating an example of a capacitive type touch screen panel according to the related art.

As illustrated in FIG. 1a, the capacitive type touch screen panel according to the related art includes a transverse linear sensor pattern 5a, a longitudinal linear sensor pattern 5b, and a touch drive IC that analyzes touch signals. Such a capacitive type touch screen panel detects the magnitude of the capacitance formed between the linear sensor pattern 5 and a finger 8, and in this instance, detects signals by scanning the transverse linear sensor pattern 5a and the longitudinal linear sensor pattern 5b, thereby recognizing a plurality of touch points.

FIG. 1b is a diagram illustrating the capacitive type touch screen panel of FIG. 1a provided on a display device 20.

Referring to FIG. 1b, the touch screen panel described in FIG. 1a is disposed on the display device 20. Thus, the linear sensor pattern 5 is disposed on a top surface of a substrate 10, and a protection panel 3 for protecting the linear sensor pattern 5 is attached on the substrate 1. The touch screen panel is adhered to the display device 20 via an adhesive member 9, and forms an air gap 9a with the display device 20.

In FIG. 1b, during a touch, a capacitance such as Ct is formed between the finger 8 and the linear sensor pattern 5, a capacitance such as Cvcom is formed between the linear sensor pattern 5 and a common electrode of the display device 20, and a parasitic capacitance Cp generated from various causes is formed in the linear sensor pattern 5.

FIG. 1c illustrates an equivalent circuit for touch detection during a touch in FIG. 1b.

Referring to FIG. 1c, when a finger contacts the linear sensor pattern 5, Cvcom, Cp, Ct, and the like are generated. A conventional touch screen panel recognizes a touch by detecting an amount of change in Ct, and therefore Cp, Cvcom, or the like may act as noise.

In a case of Cvcom, it may be determined by the structure of the display device 20 in which the touch screen panel is mounted, and may be used as a single signal in touch detection using a common electrode voltage (Vcom) in Korean Patent Application No. 10-2010-85360.

However, in a case of the parasitic capacitance Cp, the touch detection sensitivity is deteriorated along with an increase in the magnitude of the parasitic capacitance Cp, and therefore the overall performance of the touch screen is improved when Cp is removed.

However, since Cp is determined by various external environments, it is impossible to make Cp physically and completely zero.

### SUMMARY

The present invention is directed to providing a touch detection method and apparatus which may detect a touch by adding an additional capacitance for offsetting a parasitic capacitance.

One aspect of the present invention provides a capacitive type touch detection apparatus including: at least one sensor pad that outputs a signal according to a touch state in response to an alternating voltage in a floating state after charging with an electric charge; an additional electrostatic capacitive unit that is electrically connected to an output terminal of the sensor pad and has a capacitance corresponding to a parasitic capacitance of the sensor pad; an electrical charging/discharging unit that charges or discharges the additional electrostatic capacitive unit in such a manner that the additional electrostatic capacitive unit has an electric charge variation the same as that in the parasitic capacitance caused by the alternation of the alternating voltage but an opposite polarity; and a level shift detection unit that detects a touch signal based on a difference between a voltage variation in the sensor pad caused by the alternating voltage during non-touch and a voltage variation in the sensor pad caused by the alternating voltage during a touch.

The additional electrostatic capacitive unit may include a plurality of additional capacitances, and a switching unit that connects at least one of the plurality of additional capacitances and an output terminal of the electrical charging/discharging unit in response to the voltage variation in the sensor pad during non-touch.

The capacitive type touch detection apparatus may further include a control unit that controls the switching unit so that the at least one of the plurality of additional capacitances is combined and sequentially connected to an output terminal of a voltage control unit and determines a combination of the additional capacitance connected to the output terminal of the voltage control unit according to whether the voltage variation in the sensor pad during non-touch with respect to each combination satisfies a predetermined condition.

The predetermined condition may be that the voltage variation in the sensor pad during non-touch is a maximum value while being a threshold value or less.

The capacitive type touch detection apparatus may further include a storage unit in which information about the determined combination of the additional capacitance and a voltage variation corresponding to the combination are stored.

The control unit may update the combination of the additional capacitance connected to the output terminal of the voltage control unit by comparing the voltage variation in the sensor pad during non-touch and the voltage variation stored in the storage unit.

The storage unit may store the information about the determined combination of the additional capacitance and information about the voltage variation corresponding to the combination for each sensor pad or for each group of the sensor pad.

The capacitive type touch detection apparatus may further include a buffer unit that outputs an output voltage of the sensor pad by performing buffering on the output voltage of the sensor pad.

The electrical charging/discharging unit may include a voltage control unit that outputs a voltage for charging the additional electrostatic capacitive unit in response to the output voltage of the sensor pad and an external input voltage.

The switching unit may connect, to an output terminal of the buffer unit, at least one additional capacitance that is not connected to the output terminal of the electrical charging/discharging unit.

The voltage control unit may include an amplifier element that amplifies and outputs an input signal at a predetermined rate, a first resistance element that is connected to a first input terminal of the amplifier element and the external input voltage, a second resistance element that is connected to a second input terminal of the amplifier element and an output terminal of the buffer unit, and a third resistance element that is connected to the first input terminal and an output terminal of the amplifier element.

At least one of the first resistance element, the second resistance element, and the third resistance element may include a variable resistor.

The capacitive type touch detection apparatus may further include a charging means that charges the sensor pad of forming a touch capacitance with a touch object by supplying a charging signal.

Another aspect of the present invention provides a touch detection method including: a) charging at least one sensor pad of forming a touch capacitance with a touch object and then floating the charged sensor pad; b) applying an alternating voltage alternating with a predetermined frequency to the sensor pad; c) charging or discharging an electric charge to an additional electrostatic capacitive unit connected to the sensor pad so as to have polarity opposite to polarity of an electric charge charged in a parasitic capacitance; and d) detecting a touch signal based on a difference of voltage fluctuation amounts in the sensor pad by the alternating voltage before and after a touch occurs.

The c) charging or discharging may include c-1) measuring a voltage variation in the sensor pad during non-touch, and c-2) determining a combination of the additional capacitance in which the voltage variation is a maximum value while being a threshold value of less.

A touch detection method and apparatus according to an embodiment of the present invention may minimize the effect of a parasitic capacitance by adding an additional capacitance for offsetting the parasitic capacitance to an output terminal of a sensor pad, reduce performance variation between products, and increase the performance of an analog-to-digital converter (ADC) within a level shift detection unit.

In addition, a touch detection method and apparatus according to an embodiment of the present invention may adjust a change value of a potential difference applied to both ends of an additional capacitance, and therefore the effect of a parasitic capacitance may be removed even when the parasitic capacitance and the additional capacitance are different from each other.

### BRIEF DESCRIPTION OF DRAWINGS

FIG. 1a is a plan configuration diagram illustrating an example of a capacitive type touch screen panel according to the related art;

FIG. 1b is a diagram illustrating the capacitive type touch screen panel of FIG. 1a provided on a display device 20;

FIG. 1c illustrates an equivalent circuit for touch detection during a touch in FIG. 1b;

FIG. 2 is a block diagram illustrating a touch detection apparatus 200 according to an embodiment of the present invention;

FIG. 3 illustrates an equivalent circuit of a touch detection apparatus 200 according to an embodiment of the present invention;

FIG. 4 illustrates waveforms of signals within a touch detection apparatus 200 according to an embodiment of the present invention;

FIG. 5 illustrates an example of an electrical charging/discharging unit 230 according to an embodiment of the present invention;

FIG. 6 illustrates an example of an additional electrostatic capacitive unit 220 according to an embodiment of the present invention;

FIG. 7 is a specific block diagram illustrating a touch detection apparatus 200 according to an embodiment of the present invention;

FIG. 8 is a block diagram illustrating a touch detection apparatus 200 when a level shift detection unit 240 includes an amplifier 18 according to an embodiment of the present invention;

FIG. 9 is a block diagram illustrating a touch detection apparatus 200 when a level shift detection unit 240 includes a differential amplifier 18a according to an embodiment of the present invention;

FIG. 10 illustrates a structure of a memory unit in which information about a sensor pad 210 is stored according to an embodiment of the present invention; and

FIG. 11 is a flowchart illustrating a touch detection method according to an embodiment of the present invention.

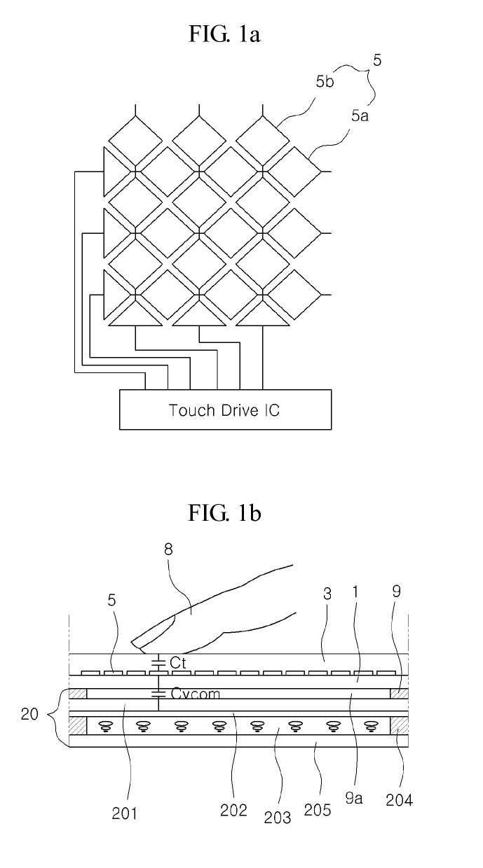

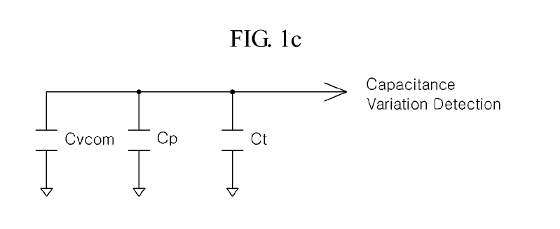

### DETAILED DESCRIPTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Hereinafter, preferred embodiments of the present invention will be described in detail with reference to the accompanying drawings.

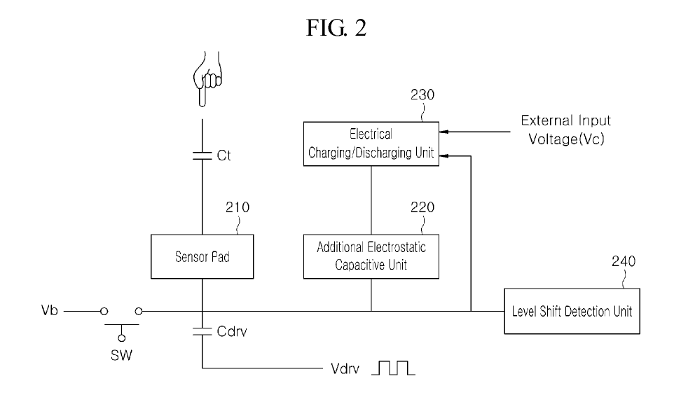

FIG. 2 is a block diagram illustrating a touch detection apparatus 200 according to an embodiment of the present invention.

The touch detection apparatus 200 according to an embodiment of the present invention may include at least one sensor pad 210, an additional electrostatic capacitive unit 220, an electrical charging/discharging unit 230, and a level shift detection unit 240.

Touch detection operations of the touch detection apparatus 200 will be described.

The sensor pad 210 forms a touch capacitance (Ct) with a touch object such as a finger or a conductor as an electrode patterned on a substrate in order to detect a touch input. The sensor pad 210 may be formed as a transparent conductor. For example, the sensor pad 210 may be made of a transparent material such as Indium Tin Oxide (ITO), Antimony Tin Oxide (ATO), Carbon Nano Tube (CNT), Indium Zinc Oxide (IZO), or the like. However, according to another embodiment of the present invention, the sensor pad 210 may be made of a metal.

The sensor pad 210 outputs a signal according to a touch state of a touch object in response to an alternating voltage (Vdrv) alternating with a predetermined frequency. As an example, the sensor pad 210 outputs a different level shift value during a touch in response to the alternating voltage (Vdrv) and during non-touch.

The touch detection apparatus 200 may further include an alternating voltage generating means (not shown) and a charging means (SW).

The charging means (SW) is connected to an output terminal of the sensor pad 210 to supply a charging signal (Vb). The charging means (SW) may be a three-terminal type switching element that performs a switching operation according to a control signal supplied to an ON/OFF control terminal, or a linear element such as OP-AMP that supplies a signal according to the control signal. A touch capacitance (Ct), a parasitic capacitance (Cp), and a driving capacitance (Cdrv) which are exerted on the sensor pad 210 are connected to an output terminal of the charging means (SW), and Ct, Cp, Cdrv, or the like may be charged by applying the charging signal (Vb) to an input terminal when the charging means (SW) is turned on. Thereafter, when the charging means (SW) is turned off, the signal charged in Ct, Cp, Cdrv, or the like is isolated in a state of being charged unless it is separately discharged. In this instance, in order to stably isolate the charged signal, an input terminal of the level shift detection unit 240 which will be described later may have a high impedance.

An electric charge which is charged to the sensor pad when the above-described charging means (SW) is turned on is isolated when the charging means (SW) is turned off Such an isolation state is referred to as a floating state. A voltage level of the electric charge of the charging signal isolated between the charging means (SW) and the level shift detection unit 240 is changed by an alternating signal applied to the outside. The voltage level is different from each other during a touch and during non-touch. Such a level difference before and after occurrence of the touch is referred to as a level shift.

The alternating voltage generating means (not shown) changes a potential in the sensor pad 210 by applying an alternating voltage (Vdrv) alternating with a predetermined frequency to the output terminal of the sensor pad 210 via the driving capacitance (Cdrv). The alternating voltage generating means may generate alternating voltages having the same duty ratio, or alternating voltages having a different duty ratio.

A common electrode (not shown) may be referred to as an electrode to which a common voltage is applied within a display device 20 or an electrode that commonly serves within the display device. For example, an LCD of the display device requires the common voltage in order to drive liquid crystal. In order to reduce current consumption, the alternating voltage alternating with a predetermined frequency is used as a common voltage in a small and medium-sized LCD, and a DC voltage is used as the common voltage in a large-sized LCD.

When a common voltage (Vcom) generated in the display device 20 is used as the alternating voltage, a common voltage capacitance (Cvcom) may act as the driving capacitance (Cdrv). In this case, the driving capacitance (Cdrv) may be temporarily removed.

In the following descriptions, a case in which the alternating voltage is used as the common voltage is not separately described in the present invention, but it will be understood that the same principle is also applied to an embodiment in which the alternating voltage is used as the common voltage and the embodiment is included in the scope of the present invention.

The level shift detection unit 240 detects a level shift generated by the alternating voltage (Vdrv) in a floating state. That is, the potential of the sensor pad 210 may be increased or decreased by the applied alternating voltage (Vdrv), and voltage level variation during a touch may have a smaller value than that during non-touch. Thus, the level shift detection unit 240 detects the level shift by comparing voltage levels before and after occurrence of the touch. The level shift detection unit 240 may be configured by a combination of various elements or circuits. For example, the level shift detection unit 240 may be configured by combining at least one of an amplifier element that amplifies a signal of the output terminal of the sensor pad 210, an Analogue to Digital Converter (ADC), a Voltage to Frequency Converter (VFC), a flip-flop, a latch, a buffer, a transistor (TR), a Thin Film Transistor (TFT), a comparator, and the like.

Hereinafter, an embodiment of the present invention in which the effect of the parasitic capacitance (Cp) is reduced will be described.

The additional electrostatic capacitive unit 220 is electrically connected to the output terminal of the sensor pad 210 and has a capacitance corresponding to the parasitic capacitance (Cp) of the sensor pad 210. The additional electrostatic capacitive unit 220 preferably has the same capacitance as the parasitic capacitance. However, the parasitic capacitance is different for each sensor pad or changed according to an external environment, and therefore it is difficult to adjust the capacitance of the additional electrostatic capacitive unit 220 as the same with the parasitic capacitance. Thus, preferably, the additional electrostatic capacitive unit 220 may be implemented so that the capacitance of the additional electrostatic capacitive unit 220 can be changed. As an example, the additional electrostatic capacitive unit 220 may include a plurality of additional capacitances, and effectively respond to the parasitic capacitance (Cp) changed according to the external environment by selecting or combining at least one of the additional capacitances.

The additional electrostatic capacitive unit 220 will be described in more detail in FIG. 6.

The output terminal of the electrical charging/discharging unit 230 is connected to the additional electrostatic capacitive unit 220 and charges or discharges a quantity of electric charge to or from the additional electrostatic capacitive unit 220. In this instance, the electrical charging/discharging unit 230 controls such that the amount of electric charge charged or discharged to or from the additional electrostatic capacitive unit 220 has the same magnitude as a quantity of electric charge charged or discharged to or from the parasitic capacitance but an opposite polarity. That is, the electrical charging/discharging unit 230 discharges the same amount of electric charge from the additional electrostatic capacitive unit 220 when the electric charge is charged to the parasitic capacitance, and charges the same amount of electric charge to the additional electrostatic capacitive unit 220 when the electric charge is discharged from the parasitic capacitance.

As an example, when the potential difference applied to the parasitic capacitance is reduced, the electric charge may be discharged from the parasitic capacitance. When the capacitance of the additional electrostatic capacitive unit 220 and the capacitance of the parasitic capacitance are the same, the electrical charging/discharging unit 230 may enable the electric charge having the same magnitude as that of the electric charge discharged from the parasitic capacitance to be charged to the additional electrostatic capacitive unit 220 by increasing the potential difference applied to the additional electrostatic capacitive unit 220 by the same size. However, even when the capacitance of the additional electrostatic capacitive unit 220 and the capacitance of the parasitic capacitance are different from each other, the electrical charging/discharging unit 230 may achieve the same effect by adjusting the potential difference applied to the additional electrostatic capacitive unit 220 to be larger (or smaller) than the change in the potential difference in the parasitic capacitance.

The electrical charging/discharging unit 230 will be described in more detail in FIG. 6.

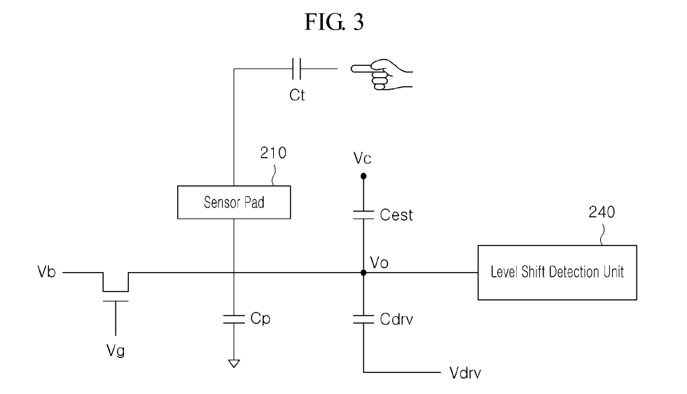

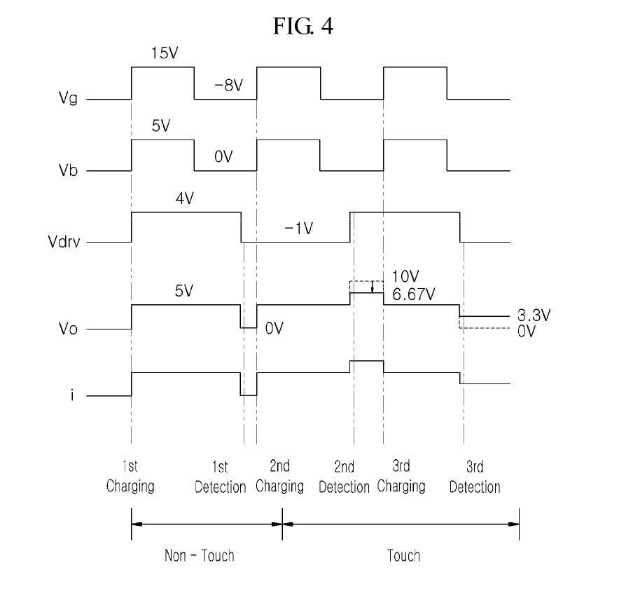

Hereinafter, specific operations of the touch detection apparatus 200 will be described with reference to FIGS. 3 and 4.

FIG. 3 illustrates an equivalent circuit of the touch detection apparatus 200 according to an embodiment of the present invention, and FIG. 4 illustrates waveforms of signals within the touch detection apparatus 200 according to an embodiment of the present invention.

Referring to FIG. 3, the touch detection apparatus 200 may include the sensor pad 210, a touch capacitance (Ct), a parasitic capacitance (Cp), an additional capacitance (Cest), a driving capacitance (Cdrv), and a transistor (Q).

First, terminologies used in FIGS. 3 and 4 will be defined as follows.

The touch capacitance (Ct) refers to a capacitance formed between the sensor pad 210 and a touch object such as a finger when a user touches the sensor pad 210.

The parasitic capacitance (Cp) refers to a capacitance accompanied by the sensor pad 210 and is a type of parasitic capacitance formed by the sensor pad 210, a signal wiring, the display device, and so on. The parasitic capacitance (Cp) may include an arbitrary parasitic capacitance generated by the level shift detection unit 240, a touch panel, and an image display apparatus.

The additional capacitance (Cest) refers to a capacitance attached to the sensor pad 210 in order to remove the effect of the parasitic capacitance (Cp), and preferably, the additional capacitance (Cest) having an electric charge with the same magnitude as that of the electric charge charged or discharged to or from the parasitic capacitance (Cp) but an opposite polarity may be charged or discharged.

The common voltage capacitance (Cvcom) refers to a capacitance formed between a common electrode (not shown) of the display device and a touch panel when the touch panel is mounted on the display device 20 such as an LCD. A common voltage (Vcom) such as square waves is applied to the common electrode by the display device. Meanwhile, the common voltage capacitance (Cvcom) is also a kind of the parasitic capacitance to be included in the parasitic capacitance (Cp), and the common voltage capacitance (Cvcom) may be included in the parasitic capacitance (Cp) unless the common voltage capacitance (Cvcom) is otherwise stated.

The driving capacitance (Cdrv) refers to a capacitance formed on a path of supplying an alternating voltage (Vdrv) alternating with a predetermined frequency to the sensor pad 210. The alternating voltage (Vdrv) applied to the driving capacitance (Cdrv) is preferably a square-wave signal. The alternating voltage (Vdrv) may have the same duty ratio, but may have a different duty ratio. The alternating voltage (Vdrv) may be provided by a separate alternating voltage generating means, but may use the common voltage (Vcom).

The transistor (Q) may be a field effect transistor. In the transistor (Q), a control signal (Vg) may be applied to a gate, a charging signal (Vb) may be applied to a source, and a drain may be connected to a signal wiring (not shown). Obviously, the source may be connected to the signal wiring, and the charging signal (Vb) may be applied to the drain. The control signal (Vg) and the charging signal (Vb) may be applied by control of a control unit (not shown). According to another embodiment of the present invention, other elements capable of performing switching rather than the transistor (Q) may be used.

Referring to FIG. 4, by turning on the transistor (Q), the charging signal (Vb) is supplied to charge the driving capacitance (Cdrv), the touch capacitance (Ct), the additional capacitance (Cest), and the parasitic capacitance (Cp). Thereafter, when turning off the transistor (Q), the charged electric charge is isolated, and therefore the potential in the output terminal of the sensor pad 210 may be maintained.

According to the present embodiment, it is assumed that an ON voltage of the transistor (Q) is smaller than 15V and an OFF voltage is larger than −8V. In addition, it is assumed that a voltage of the charging signal (Vb) is 5V and the alternating voltage (Vdrv) is 4V at a high level and −1V at a low level.

First, a case in which no touch occurs on the sensor pad 210 using the touch object will be described.

In a first charging process, when a control signal (Vg=15V) is applied to the gate of the transistor (Q), the transistor (Q) is turned on, and the charging signal (Vb) is applied to the output terminal of the sensor pad (210). Thus, a voltage (Vo) in the output terminal of the sensor pad 210 gradually and gently increases and then becomes 5V. An electric charge is charged even to the driving capacitance (Cdrv), the touch capacitance (Ct), the additional capacitance (Cest), and the parasitic capacitance (Cp) by the charging voltage (Vb). In the first charging, since the transistor (Q) is turned on, the alternating voltage (Vdrv) does not affect the output voltage (Vo).

Thereafter, when a control signal (Vg=−8V) is applied to the gate of the transistor (Q), the driving capacitance (Cdrv), the touch capacitance (Ct), the additional capacitance (Cest), and the parasitic capacitance (Cp) are isolated in a state of being charged while the transistor (Q) is turned off. In this instance, in order to stably isolate the charged electric charge, the input terminal of the level shift detection unit 240 may have a high impedance.

A state in which the charged electric charge is isolated in the sensor pad 210 or the like is referred to as a floating state. Thus, the voltage (Vo) in the output terminal of the sensor pad 210 may be maintained as 5V.

In this instance, when the alternating voltage (Vdrv) applied to the driving capacitance (Cdrv) is increased, for example, from 0V to 5V, the level of the output voltage (Vo) of the sensor pad 210 may be momentarily increased, and when the alternating voltage is decreased from 5V to 0V, the level of the output voltage (Vo) may be momentarily decreased. In this instance, the increase and decrease of the voltage level has a different value according to the connected capacitance. According to the connected capacitance, a phenomenon in which an increase value or a decrease value of the voltage level is changed may be called “kick-back”.

As described above, in a first detection process, when the voltage of the alternating voltage (Vdrv) is decreased, a phenomenon in which the voltage (Vo) level in the output terminal of the sensor pad 210 is momentarily decreased occurs.

In the first detection process, when no touch input occurs in the sensor pad 210, that is, when only the driving capacitance (Cdrv), the additional capacitance (Cest), and the parasitic capacitance (Cp) are present as the capacitance connected to the sensor pad 210, the output voltage (Vo) is changed according to the following Equation 1.

$$Δ {V}_{o} = \pm ( {V}_{drvH} - {V}_{drvL} ) \frac{{C}_{drv}}{{C}_{drv} + {C}_{p} + {C}_{est}} \qquad [ Equation 1 ]$$

Here, ΔVo denotes a voltage variation in the output terminal of the sensor pad 210, VdrvH denotes a high level voltage of the alternating voltage, VdrvL denotes a low level voltage of the alternating voltage, Cdrv denotes an excitation capacitance, Cp denotes a parasitic capacitance, and Cest denotes an additional capacitance.

When Cest is set so that Cp=−Cest is satisfied, ΔVo becomes −(−4−(−1))*1=−5V based on Equation 1, and the voltage level (Vo) in the output terminal of the sensor pad 210 is changed from 5V to 0V. Meanwhile, in contrast to the above-mentioned example, when a detection operation is performed in an increase interval of the alternating voltage in a state in to which no touch occurs, ΔVo=5V is satisfied, and the voltage level (Vo) in the output terminal is changed from 5V to 10V.

Next, a case in which a touch occurs on the sensor pad 210 using the touch object will be described.

In a second charging process, when the control signal (Vg=15V) is applied to the gate of the transistor (Q) again, the transistor (Q) is turned on and the charging signal (Vb) is applied to the output terminal of the sensor pad 210 again. Thus, the voltage (Vo) in the output terminal of the sensor pad 210 becomes 5V again.

In a second detection process, when the voltage of the alternating voltage (Vdrv) is increased, the voltage (Vo) level in the output terminal of the sensor pad 210 is momentarily increased.

Since a touch input occurs in the second detection process, the touch capacitance (Ct) formed between the finger and the sensor pad 210 is exerted. Thus, the touch capacitance (Ct) other than the driving capacitance (Cdrv), the additional capacitance (Cest), and the parasitic capacitance (Cp) is added as the capacitance connected to the sensor pad 210, and therefore the voltage (Vo) is changed according to the following Equation 2.

$$Δ {V}_{o} = \pm ( {V}_{drvH} - {V}_{drvL} ) \frac{{C}_{drv}}{{C}_{drv} + {C}_{p} + {C}_{est} + {C}_{t}} \qquad [ Equation 2 ]$$

Here, Ct denotes the touch capacitance.

When comparing Equation 1 and Equation 2, Equation 2 is obtained by adding the touch capacitance (Ct) to the denominator of Equation 1, and therefore a voltage variation during a touch is smaller than a voltage variation during non-touch, and a difference between the voltage variations may be changed according to the touch capacitance (Ct). The difference in the voltage variation (ΔVo) before and after occurrence of the touch is referred to as a “level shift”. In the present specification, the “level shift” may refer to a digital value of the difference in the voltage variation (ΔVo).

When Cest is set so that Ct=2Cdrv and Cp=−Cest are satisfied, ΔVo becomes (−4−(−1))*⅓=1.67V based on Equation 2, and the voltage level (Vo) in the output terminal of the sensor pad 210 is changed from 5V to 6.67V.

When no touch input occurs, the voltage (Vo) level in the output terminal of the sensor pad 210 is changed from 5V to 10V based on Equation 1, but when a touch input occurs, the voltage (Vo) level in the output terminal of the sensor pad 210 becomes 6.67V. That is, the voltage (Vo) level in the output terminal of the sensor pad 210 during a touch compared to during non-touch is shifted from 10V to 6.67V. Thus, by detecting such a level shift, a touch signal may be obtained.

In a third charging process, the voltage (Vo) in the output terminal of the sensor pad 210 becomes 5V again, and in a third detection process, a touch input occurs, and therefore the voltage (Vo) level in the output terminal of the sensor pad 210 is decreased to 3.33V based on Equation 2 when the voltage of the alternating voltage (Vdrv) is decreased. That is, the voltage (Vo) is level-shifted downward in an increase interval of the alternating voltage (Vdrv) when the touch input occurs, and the voltage (Vo) is level-shifted upward in a decrease interval of the alternating voltage (Vdrv).

Consequently, the level shift value corresponds to a touch detection value, and touch detection performance is increased along with an increase in the level shift value. However, when the parasitic capacitance (Cp) is increased in the denominators of Equations 1 and 2, the level shift value may be reduced. Thus, according to an embodiment of the present invention, by reducing the parasitic capacitance (Cp) using the additional capacitance (Cest), the touch detection performance may be improved. A capacitance having physically a negative (−) value does not exist, but the electrical charging/discharging unit 230 according to the present invention performs the same function as applying the additional capacitance (Cest) having a negative value of the parasitic capacitance (Cp) through charging and discharging of electric charge.

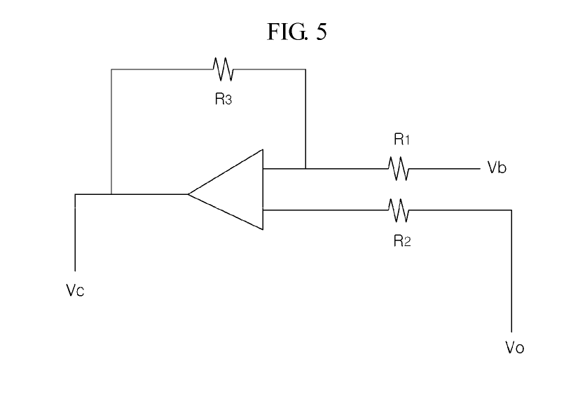

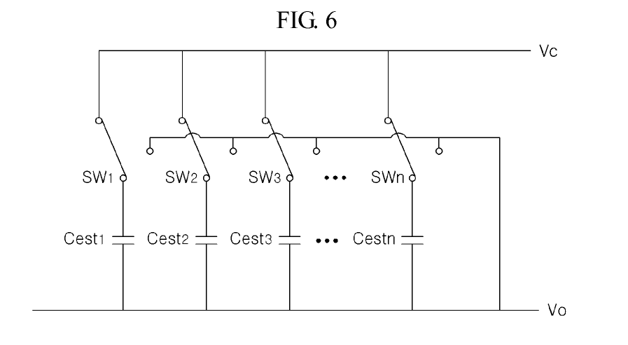

FIG. 5 illustrates an example of the electrical charging/discharging unit 230 according to an embodiment of the present invention.

The electrical charging/discharging unit 230 according to an embodiment of the present invention includes an amplifier element and resistors R1, R2, and R3.

One end of the resistor R1 is connected to a first input terminal of the amplifier element, and an external input voltage (Vb) is applied to the other end of the resistor R1. The external input voltage (Vb) may be the charging signal of FIGS. 3 and 4.

One end of the resistor R2 is connected to a second input terminal of the amplifier element, and the voltage (Vo) in the output terminal of the sensor pad 210 is applied to the other end of the resistor R2. According to an embodiment, an output terminal of a buffer unit (not shown) that performs buffering on the voltage in the output terminal of the sensor pad 210 may be connected to the other end of the resistor R2.

One end of the resistor R3 is connected to the output terminal of the amplifier element, and the first input terminal of the amplifier element and the one end of the resistor R1 are connected to the other end of the resistor R3.

In FIG. 5, the voltage levels in the first and second input terminals of the amplifier element are the same, and therefore the voltage (Vo) in the output terminal is determined according to the following Equation 3.

$$\frac{{V}_{b} - {V}_{o}}{R 1} = \frac{{V}_{o} - {V}_{c}}{R 3} \qquad [ Equation 3 ]$$

Hereinafter, for convenience of description, when it is assumed that R1=R2=R3 and Vb is the charging signal (Vb) of FIG. 3, VC=2Vo−Vb may be satisfied.

First, a case in which the charging means is turned on to be charged is assumed. In this case, Vo of the amplifier element is equal to Vb so that the voltage levels of the first and second input terminals become Vb, whereby Vc=Vb is satisfied. Thus, a difference in the potential applied to both ends of the additional capacitance (Cest) is zero. In addition, a difference in the potential applied to both ends of the parasitic capacitance (Cp) is Vb.

Next, a case in which the alternating voltage (Vdrv) is applied in a floating state after charging is completed so that a change in the voltage level is generated is assumed. In this case, Vc=2Vo−Vb is satisfied based on Equation 3. In addition, the voltage (Vo) in the output terminal of the sensor pad 210 is equal to Vb−ΔVo, Vc=2(Vb−ΔVo)−Vb=Vb−2ΔVo is satisfied.

The difference (Vest) of the potentials applied to both ends of the additional electrostatic capacitive unit 220 corresponds to a difference between the voltage in the output terminal of the amplifier element and the voltage in the output terminal of the sensor pad 210, and therefore Vcest=Vc−Vo=(Vb−2ΔVo)−(Vb−ΔVo)=−ΔVo is satisfied.

Thus, the variation of the difference in the potentials applied to the both ends of the additional electrostatic capacitive unit 220 satisfies: (ΔVcest)=0−(−ΔVo)=ΔVo.

Meanwhile, a relationship of Q (amount of electric charge)=C (capacitance)*V (voltage) is achieved, and therefore a quantity of electric charge forming Cp is moved to Cest when Cp and Cest substantially have the same value, whereby it is possible to remove the effect of Cp. That is, when the voltage level of the alternating voltage (Vdrv) is increased (or decreased), the electric charge taken by the parasitic capacitance (Cp) (or electric charge put out by the parasitic capacitance (Cp)) is moved from (or to) the additional electrostatic capacitive unit 220. Consequently, according to an embodiment of the present invention, when the parasitic capacitance (Cp) is similar to the capacitance (Cest) of the additional electrostatic capacitive unit 220, the electric charge by the parasitic capacitance (Cp) does not affect the driving capacitance (Cdrv), and therefore variation between products may be minimized and performance of ADC may be maximally utilized. In FIG. 5, a case in which the parasitic capacitance (Cp) is similar to the capacitance (Cest) of the additional electrostatic capacitive unit 220 is assumed, but in a case in which the parasitic capacitance (Cp) is different from the capacitance (Cest) of the additional electrostatic capacitive unit 220, the voltage level in the output terminal of the amplifier element is adjusted by changing a value of R3 that is a feedback resistor, thereby obtaining the same effect.

FIG. 6 illustrates an example of the additional electrostatic capacitive unit 220 according to an embodiment of the present invention.

The additional electrostatic capacitive unit 220 may include a plurality of additional capacitances Cest1, Cest2, . . . , and Cestn and a plurality of switches SW1, SW2, . . . , and SWn. In addition, the plurality of switches SW1, SW2, . . . , and SWn receive a switching control signal from the control unit (not shown) to perform a switching operation.

In FIG. 5, in a case of R1=R2=R3 as described above, in order to minimize the effect of the parasitic capacitance (Cp), an adjustment operation of adjusting the capacitance (Cest) of the additional electrostatic capacitive unit 220 as the same as the capacitance of the parasitic capacitance (Cp) is performed, and then a sensing operation of performing touch detection is performed.

1. Adjustment Operation

The control unit (not shown) selects at least one combination among the plurality of additional capacitances, and transmits a control signal to the corresponding switch so that the selected additional capacitances are connected to the output terminal of the electrical charging/discharging unit 230. In this instance, the control unit (not shown) may control the switch so that the additional capacitances which are not selected enter a floating state, but control the switch so that the additional capacitances which are not selected are connected to a line having the voltage level of Vo. In the latter case, the voltage of Vo is applied to both ends of the additional capacitances which are not selected, so that the same effect as that when the corresponding additional capacitances do not exist in a circuit may be achieved.

Thereafter, the control unit measures a voltage variation (or ADC output value) in the output terminal of the sensor pad 210 during non-touch in a state in which the selected additional capacitances are connected to the output terminal of the electrical charging/discharging unit 230. For example, the control unit determines whether the voltage variation is a threshold value (for example, driving voltage level) or less, and when the voltage variation is the threshold value or less, the control unit records the voltage variation in a predetermined storage space, and otherwise, the control unit eliminates the voltage variation.

Next, the control unit selects additional capacitances having other combinations, and transmits the control signal to the corresponding switch so that the selected additional capacitances are connected to the output terminal of the electrical charging/discharging unit 230.

Next, the control unit measures a voltage variation in the output terminal of the sensor pad 210 during non-touch in a state in which the selected additional capacitances are connected to the output terminal of the electrical charging/discharging unit 230, determines whether the voltage variation is a threshold value or less, and then eliminates the voltage variation when the voltage variation is larger than the threshold value. When the voltage variation is the threshold value (or ADC output value) or less, the previously recorded voltage variation and the newly measured voltage variation are compared, an existing value is corrected as the newly measured voltage variation when the newly measured voltage variation is larger than the previously recorded voltage variation, and the corrected value is recorded in the predetermined storage space. In addition, information about newly selected additional capacitances is stored.

In this manner, the control unit controls the switching unit so that at least one of the plurality of additional capacitances is combined to be sequentially connected to the output terminal of the voltage control unit, measures a voltage variation in the sensor pad 210 during non-touch with respect to each combination, and determines the combination of the additional capacitances when the measured voltage variation is a maximum value while it is the threshold value or less.

In some cases, the magnitude of the capacitance of the parasitic capacitance (Cp) exceeds a maximum capacitance of the combination of the additional capacitances, whereby the adjustment operation is not smoothly performed. In this case, by changing the value of the resistor R3 of FIG. 5, the adjustment operation may be completed.

2. Sensing operation

The control unit controls the switches so that the at least one combination of the additional capacitances determined in the adjustment operation is connected to the output terminal of the electrical charging/discharging unit 230, and then starts touch detection.

When the measured voltage variation (or ADC output value) is larger than a value recorded in advance, the control unit performs the adjustment operation again.

Meanwhile, when the measured voltage variation is smaller than the value recorded in advance, a case in which the parasitic capacitance is changed and a case in which a touch input occurs may be separated.

When the measured voltage variation is smaller than the recorded value, it is determined as the case in which the touch input occurs, and the measured value may be used as a touch detection value. However, when the measured value is maintained without any change for a predetermined period of time or longer, it is determined as a case in which the parasitic capacitance is changed, and the adjustment operation may be performed again.

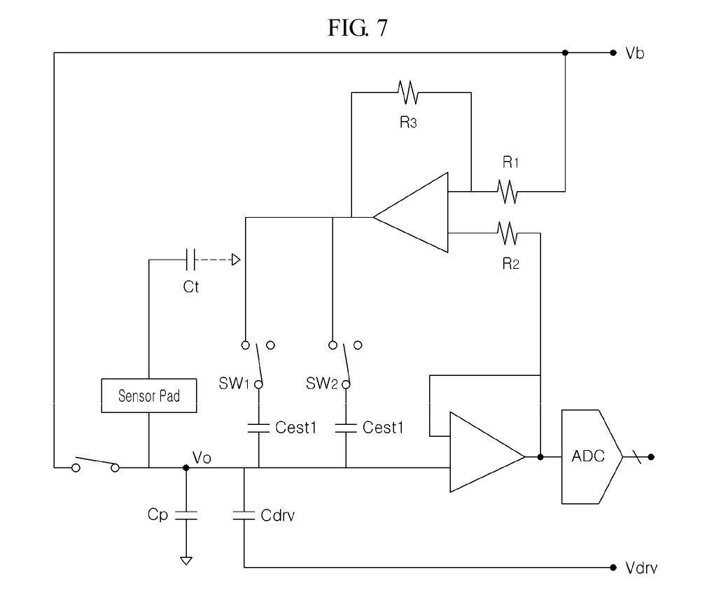

FIG. 7 is a specific block diagram illustrating the touch detection apparatus 200 according to an embodiment of the present invention.

Although not shown in FIG. 7, one end of the switches SW1 and SW2 connected to the additional capacitances Cest1 and Cest2 may be connected to a line of Vo level on which buffering has been performed, as described above.

Descriptions of respective components are the same as those in FIGS. 2 to 6, and thus will be omitted.

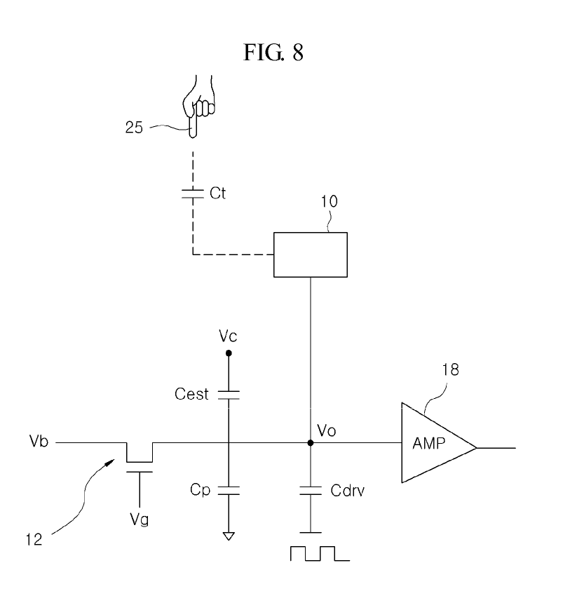

FIG. 8 is a block diagram illustrating the touch detection apparatus 200 when the level shift detection unit 240 includes an amplifier 18 according to an embodiment of the present invention.

An input terminal of the amplifier 18 is a high impedance, and thereby may stably isolate a signal in the output terminal of the sensor pad 210. The amplifier 18 amplifies the signal in the output terminal of the sensor pad 210, and therefore the size of the level shift by occurrence of the touch is amplified via the amplifier 18 to be output. Thus, it is possible to more stably detect the touch signal. The amplified signal may be input to the ADC.

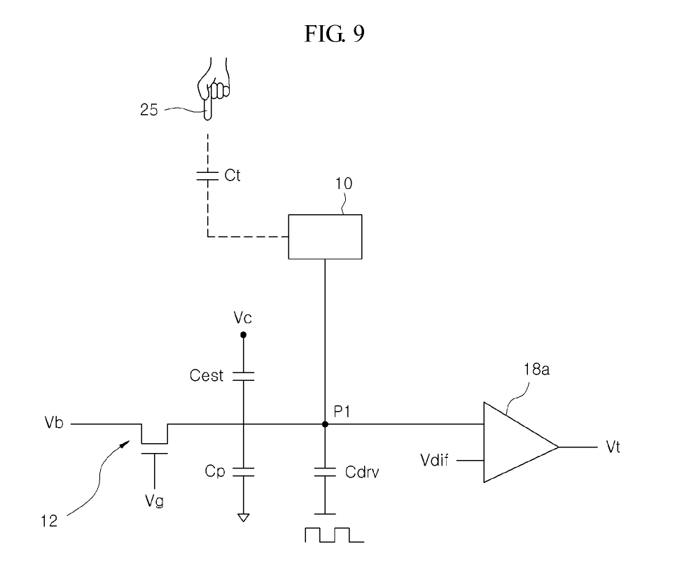

FIG. 9 is a block diagram illustrating the touch detection apparatus 200 when the level shift detection unit 240 includes a differential amplifier 18a according to an embodiment of the present invention.

The differential amplifier 18a differentially amplifies the signal in the output terminal of the sensor pad 210 according to an inversion or non-inversion differential input voltage Vdif. Vdif may be a signal corresponding to the charging signal (Vb) or the signal in the output terminal of the sensor pad 210 during non-touch. In this manner, when Vdif is the signal in the output terminal of the sensor pad 210 during non-touch, the ADC may obtain the touch signal only using the output value of the differential amplifier 18a.

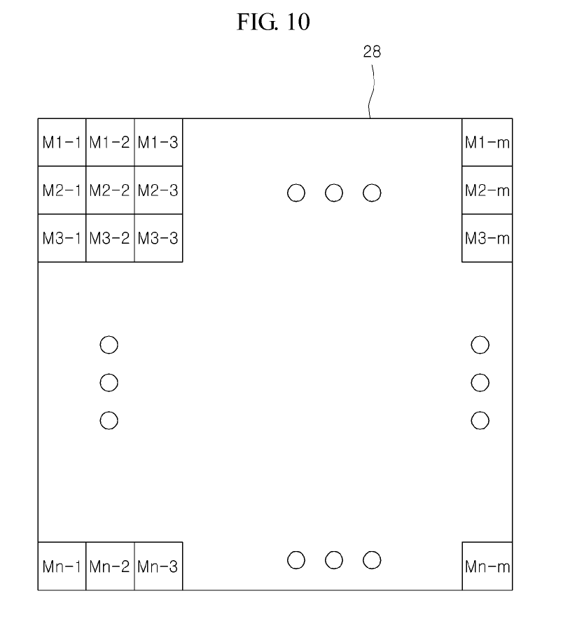

FIG. 10 illustrates a structure of a memory unit in which information about the sensor pad 210 is stored according to an embodiment of the present invention.

In the memory unit, information about the signal in the output terminal of the corresponding sensor pad 210 during non-touch may be stored for each sensor pad 210 or for each group of the sensor pad (for example, the same row or the same column) The information may be used to determine the additional capacitance for minimizing the parasitic capacitance. In addition, in the memory unit, information about the additional capacitance connected to the output terminal of the electrical charging/discharging unit 230 among the plurality of additional capacitances may be stored for each sensor pad 210.

The parasitic capacitance (Cp) and the driving capacitance (Cdrv) may be different for each sensor pad 210. This is because it is impossible to design a position of the sensor pad 210, a length of a wiring, other external factors, and the like equally with respect to all of the sensor pads 210.

However, according to an embodiment of the present invention, information about the signal (for example, voltage) in the output terminal during non-touch in the memory unit and information about the additional capacitance connected to the output terminal of the electrical charging/discharging unit 230 among the plurality of additional capacitances are stored and managed for each sensor pad 210, and therefore a touch may be effectively detected even when characteristics of the sensor pads 210 are different from each other.

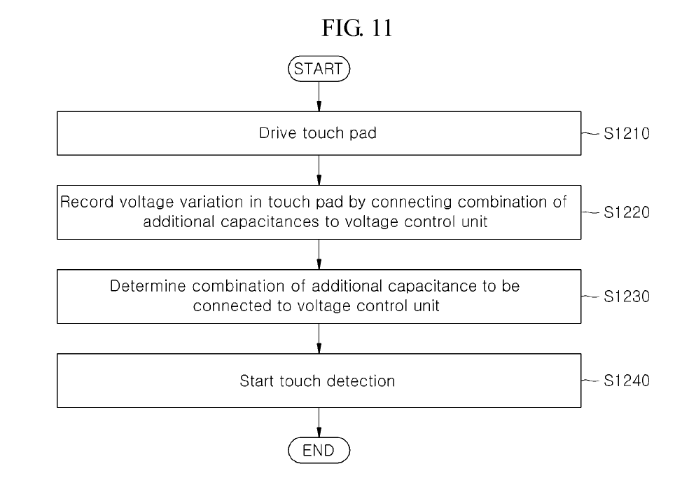

FIG. 11 is a flowchart illustrating a touch detection method according to an embodiment of the present invention.

In operation S1210, the touch pad 210 is driven. Specifically, the capacitance connected to the touch pad 210 such as Cdrv is charged by applying the charging signal (Vb) to the output terminal of the touch pad 210, and an alternating voltage (Vdrv) is applied to the output terminal of the sensor pad 210.

In operation S1220, at least one of the plurality of additional capacitances is combined to be sequentially connected to the output terminal of the voltage control unit that generates a specific voltage, and a voltage variation in the sensor pad 210 during non-touch is detected.

In operation S1230, based on the voltage variation detected in operation S1220, the combination of the additional capacitance to be connected to the output terminal of the voltage control unit is determined. For example, the combination of the additional capacitance in which the detected voltage variation is a maximum or a difference between the voltage variation and a reference voltage value is a minimum may be selected. In order to minimize the parasitic capacitance, operations S1220 and S1230 may be repeatedly or periodically performed.

In operation S1240, a touch is detected by connecting the determined combination of the additional capacitance to the output terminal of the voltage control unit.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

1. A capacitive type touch detection apparatus, comprising:
at least one sensor pad that outputs a signal according to a touch state in response to an alternating voltage in a floating state after charging with an electric charge, said at least one sensor pad having an output terminal;
an additional electrostatic capacitive unit that is electrically connected to the output terminal of the at least one sensor pad and has a capacitance corresponding to a parasitic capacitance of the at least one sensor pad;
an electrical charging/discharging unit that charges or discharges the additional electrostatic capacitive unit in such a manner that the additional electrostatic capacitive unit has an electric charge variation the same as that in the parasitic capacitance caused by the alternation of the alternating voltage but an opposite polarity, an electrical charging/discharging unit having an output terminal; and
a level shift detection unit that detects a touch signal based on a difference between a voltage variation in the sensor pad caused by the alternating voltage during non-touch and a voltage variation in the sensor pad caused by the alternating voltage during a touch.

2. The capacitive type touch detection apparatus of claim 1, wherein the additional electrostatic capacitive unit includes:
a plurality of additional capacitances; and
a switching unit that connects at least one of the plurality of additional capacitances and the output terminal of the electrical charging/discharging unit in response to the voltage variation in the sensor pad during non-touch.

3. The capacitive type touch detection apparatus of claim 9, further comprising:
a control unit that controls the switching unit so that the at least two of the plurality of additional capacitances is combined and sequentially connected to the output terminal of the voltage control unit, and determines a combination of the additional capacitance connected to the output terminal of the voltage control unit according to whether the voltage variation in the sensor pad during non-touch with respect to each combination satisfies a predetermined condition.

4. The capacitive type touch detection apparatus of claim 3, wherein the predetermined condition is that the voltage variation in the sensor pad during non-touch is a maximum value while being a threshold value or less.

5. The capacitive type touch detection apparatus of claim 4, further comprising:
a storage unit in which information about the determined combination of the additional capacitance and the voltage variation corresponding to the combination are stored.

6. The capacitive type touch detection apparatus of claim 5, wherein the control unit updates the combination of the additional capacitance connected to the output terminal of the voltage control unit by comparing the voltage variation in the sensor pad during non-touch and the voltage variation stored in the storage unit.

7. The capacitive type touch detection apparatus of claim 5, wherein the storage unit stores the information about the determined combination of the additional capacitance and information about the voltage variation corresponding to the combination for each sensor pad or for each group of the sensor pad.

8. The capacitive type touch detection apparatus of claim 2, further comprising:
a buffer unit that outputs an output voltage of the sensor pad by performing buffering on the output voltage of the sensor pad and has an output terminal.

9. The capacitive type touch detection apparatus of claim 8, wherein the electrical charging/discharging unit includes a voltage control unit that outputs a voltage for charging the additional electrostatic capacitive unit in response to the output voltage of the sensor pad and an external input voltage.

10. The capacitive type touch detection apparatus of claim 8, wherein the switching unit connects, to the output terminal of the buffer unit, at least one additional capacitance that is not connected to the output terminal of the electrical charging/discharging unit.

11. The capacitive type touch detection apparatus of claim 9, wherein the voltage control unit includes:
an amplifier element that amplifies and outputs an input signal at a predetermined rate, the amplifier element having a first input terminal, a second input terminal, and an output terminal;
a first resistance element that is connected to the first input terminal of the amplifier element and the external input voltage,
a second resistance element that is connected to the second input terminal of the amplifier element and the output terminal of the buffer unit, and
a third resistance element that is connected to the first input terminal and the output terminal of the amplifier element.

12. The capacitive type touch detection apparatus of claim 11, wherein at least one of the first resistance element, the second resistance element, and the third resistance element includes a variable resistor.

13. The capacitive type touch detection apparatus of claim 1, further comprising:
a charging unit that charges the sensor pad of forming a touch capacitance with a touch object by supplying a charging signal.

14. A touch detection method comprising:
charging at least one sensor pad of forming a touch capacitance with a touch object and then floating the charged sensor pad;
applying an alternating voltage alternating with a predetermined frequency to the sensor pad;
charging or discharging an electric charge to an additional electrostatic capacitive unit connected to the sensor pad so as to have polarity opposite to polarity of an electric charge charged in a parasitic capacitance; and
detecting a touch signal based on a difference of voltage fluctuation amounts in the sensor pad by the alternating voltage before and after a touch occurs.

15. The touch detection method of claim 14, wherein the charging or discharging includes:
measuring a voltage variation in the sensor pad during non-touch, and
determining a combination of the additional capacitance in which the voltage variation is a maximum value while being a threshold value of less.
